(19) United States
(12) Patent Application Publication
(10) Pub. No.: US 2009/0203808 A1
(43) Pub. Date: Aug. 13, 2009

(54) EXPANDABLE PARTICULATE POLYMER COMPOSITION

(75) Inventors: Paul E. Arch, Coraopolis, PA (US); Jennifer Chen, Calgary (CA); Willem van Liemt, Vinkenbos (NL); Rick Salvador, Vancouver (CA)

Correspondence Address: NOVA Chemicals Inc., Westpointe Center, 1550 Coraopolis Heights Road, Moon Township, PA, 15108, US

(73) Assignee: NOVA CHEMICALS INC., Moon Township, PA (US)

(21) Appl. No.: 12/350,987

(22) Filed: Jan. 9, 2009

Related U.S. Application Data
(60) Provisional application No. 61/027,847, filed on Feb. 12, 2008.

(51) Int. Cl. C08J 9/16

(52) U.S. Cl. 521/59

(57) ABSTRACT

An expandable particulate interpenetrating network polymer composition that includes as an expansion agent pentafluorobutane and optionally a minor amount of heptafluoropropane is described. The expandable particulate interpenetrating network polymer, more particularly, includes a particulate interpenetrating network polymer that includes: (i) a polyolefin polymer present in an amount of from 10 percent by weight to 80 percent by weight; and (ii) a vinyl aromatic polymer present in an amount of from 20 percent by weight to 90 percent by weight, in each case based on total weight of the particulate interpenetrating network polymer. The expansion agent resides (or is impregnated) within the particulate interpenetrating network polymer. The pentafluorobutane may be 1,1,1,3,3-pentafluorobutane, and the heptafluoropropane may be 1,1,1,2,3,3,3-heptafluoropropane. In an embodiment, the expansion agent consists of 1,1,1,3,3-pentafluorobutane, and is substantially free of any other expansion agents. The expandable particulate interpenetrating network polymer compositions of the present invention have improved expansion agent retention values, relative to comparative expandable particulate interpenetrating network polymer compositions (e.g., containing isopentane as an expansion agent).

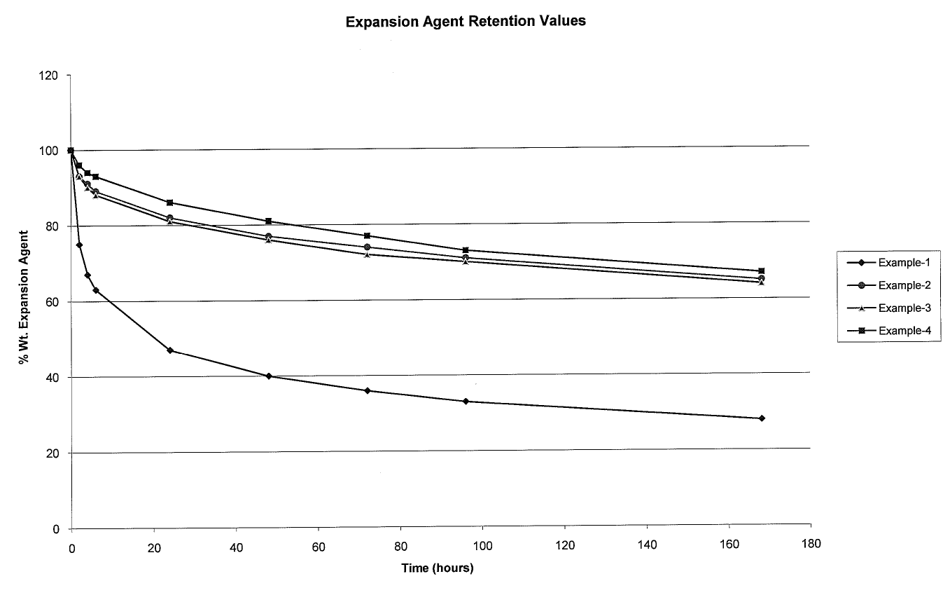

### CROSS REFERENCE TO RELATED PATENT APPLICATION

The present non-provisional patent application is entitled to and claims, under 35 U.S.C. §119(e), the benefit of U.S. Provisional Patent Application Ser. No. 61/027,847, filed 12 Feb. 2008, which is hereby incorporated herein by reference in its entirety.

### FIELD OF THE INVENTION

The present invention relates to expandable particulate interpenetrating network polymer compositions. The expandable particulate polymer composition includes a particulate interpenetrating network polymer comprising polyolefin, and a vinyl aromatic polymer, and an expansion agent. The expansion agent is composed of pentafluorobutane and optionally a minor amount of heptafluoropropane, and resides within the particulate interpenetrating network polymer. The interpenetrating network polymer is typically formed by polymerization of a vinyl aromatic monomer composition within particulate polyolefin polymer.

### BACKGROUND OF THE INVENTION

Expandable particulate interpenetrating network polymers are generally known. Interpenetrating network polymers are typically formed by polymerizing a monomer composition (e.g., a vinyl aromatic monomer composition comprising styrene) within a particulate polymer (e.g., particulate polyolefin material, such as polyethylene). Polymerization of a vinyl aromatic monomer composition (e.g., styrene) at least partially within the particulate polyolefin (e.g., polyethylene) results in formation of a particulate interpenetrating network polymer. Particulate interpenetrating network polymers typically provide improved physical properties, such as impact resistance, relative to comparative materials having the same polymer (or monomer) ratios, e.g., a physical mixture or blend of the separate polymers, or a copolymer formed from monomers of the polymers. The improved physical properties are more particularly evidenced with molded articles prepared from expanded particulate interpenetrating network polymers, as will be discussed further below.

To render the particulate interpenetrating network polymer material expandable, an expansion agent is typically infused or impregnated into the particulate material, often under conditions of elevated temperature and pressure. The expansion agent generally includes one or more alkanes having less than six carbon atoms (e.g., n-butane, iso-pentane and/or n-pentane). The expandable particulate interpenetrating network polymer material, having an expansion agent impregnated therein, is typically introduced into an expander. Upon exposure to elevated temperature within the expander, the expansion agent expands (e.g., becoming at least partially volatile), thus causing the expandable particulate interpenetrating network polymer material to expand or foam. Volatile expansion agent is typically vented from the expander during the expansion process.

The expanded particulate interpenetrating network polymer, after an optional storage (or aging) period at ambient conditions, is then charged to a mold where it is exposed to elevated temperature and pressure. The abutting surfaces of the expanded interpenetrating network polymer particles fuse together, resulting in the formation of a molded article. Residual volatile expansion agent that may be present in the expanded particles, is typically vented from the mold during the molding process.

For reasons including, but not limited to, safety and processing logistics, it is often desirable to perform the expansion agent impregnation and expansion/molding operations at separate locations. Typically, the expandable particulate interpenetrating network polymer material is formed at a polymer production facility, and then shipped (in an unexpanded form) to a molding facility where the expansion and molding operations take place. Since the expansion agent is often a volatile material, it may be lost from the expandable particulate material in the interim between the impregnation and expansion/molding processes. If too much expansion agent is lost from the expandable particulate material in the interim period, it will not undergo sufficient expansion during the expansion process, resulting in molded articles having undesirable physical properties (e.g., high density) and/or aesthetic properties.

To minimize loss of expansion agent, the expandable particulate material may be stored at reduced temperature and/or under sealed conditions prior to the expansion and molding operations. Storing and/or shipping the expandable particulate interpenetrating network polymer material in sealed containers and/or under conditions of reduced temperature, generally results in increased shipping and storage costs. In addition, loss of expansion agent from the expandable particulate material, during shipping and/or storage, may raise environmental and/or safety issues.

It would be desirable to develop particulate expandable interpenetrating network polymer compositions that provide improved expansion agent retention properties. It would be further desirable that molded articles prepared from such newly developed expandable interpenetrating network polymer compositions possess physical properties that are least equivalent to those of molded articles prepared from comparative expandable particulate interpenetrating network polymer materials.

U.S. Pat. No. 6,476,080 B2 discloses a blowing agent composition that includes: a mid-range low-boiling hydrofluorocarbon having a boiling point of 30 ° C. or higher and lower than 120° C.; a low-range low-boiling hydrofluorocarbon having a boiling point lower than 30° C.; and a low-boiling alcohol and/or a lower-boiling carbonyl compound. The '080 Patent also discloses foamable polymer compositions containing such blowing agent compositions. The foamable polymer compositions, disclosed in the '080 Patent are prepared by extrusion, and are expanded by passage through a slit die.

### SUMMARY OF THE INVENTION

In accordance with the present invention, there is provided an expandable particulate interpenetrating network polymer comprising:
(a) a particulate interpenetrating network polymer comprising,
   (i) a polyolefin polymer present in an amount of from 10 percent by weight to 80 percent by weight, based on total weight of the particulate interpenetrating network polymer, and
   (ii) a vinyl aromatic polymer present in an amount of from 20 percent by weight to 90 percent by weight, based on total weight of the particulate interpenetrating network polymer; and
(b) an expansion agent comprising pentafluorobutane, and optionally a minor amount of heptafluoropropane (based on the total amount, e.g., weight, of pentafluorobutane and heptafluoropropane),
   wherein the expansion agent resides substantially within the particulate interpenetrating network polymer.

As used herein and in the claims, the term “(meth)acrylic acid” and similar terms, means acrylic acid, methacrylic acid and combinations thereof. As used herein and in the claims, the term “esters of (meth)acrylic acid” and similar terms, such as “(meth)acrylate” means esters of acrylic acid (or acrylates), esters of methacrylic acid (or methacrylates) and combinations thereof.

Other than in the operating examples, or where otherwise-indicated, all numbers or expressions referring to quantities of ingredients, reaction conditions, etc. used in the specification and claims are to be understood as modified in all instances by the term “about”.

### BRIEF DESCRIPTION OF THE DRAWING

The drawing Figure is a graphical representation of plots of the percent weight of expansion agent retained within various particulate interpenetrating network polymer samples, as a function of time, the data being drawn from Table 3 of the Examples further herein.

### DETAILED DESCRIPTION OF THE INVENTION

There are provided, in accordance with the present invention, certain expandable particulate interpenetrating network polymer compositions as summarized above, that include a polyolefin polymer. As used herein and in the claims, the term “polyolefin” and similar terms, such as “polyalkylene” and “thermoplastic polyolefin,” means one or more polyolefin homopolymers, one or more polyolefin copolymers, one or more homogeneous polyolefins, one or more heterogeneous polyolefins, and blends of two or more thereof. For purposes of illustration, examples of polyolefin copolymers include, but are not limited to, those prepared from ethylene and at least one of: one or more C₃-C₁₂ alpha-olefins, such as 1-butene, 1-hexene and/or 1-octene; vinyl acetate; vinyl chloride; (meth)acrylic acid; and esters of (meth)acrylic acid, such as C₁-C₈-(meth)acrylates.

The polyolefin of the particulate interpenetrating network polymer of the present invention may be selected from heterogeneous polyolefins, homogeneous polyolefins, or combinations thereof. The term “heterogeneous polyolefin” and similar terms means polyolefins having a relatively wide variation in: (i) molecular weight amongst individual polymer chains (i.e., a polydispersity index of greater than or equal to 3); and (ii) monomer residue distribution (in the case of copolymers) amongst individual polymer chains. The term “polydispersity index” (PDI) means the ratio of M_{w}/Mₙ, where M_{w} means weight average molecular weight, and Mₙ means number average molecular weight, each being determined by means of gel permeation chromatography (GPC) using appropriate standards, such as polyethylene standards. Heterogeneous polyolefins are typically prepared by means of Ziegler-Natta type catalysis in heterogeneous phase.

The term “homogeneous polyolefin” and similar terms means polyolefins having a relatively narrow variation in: (i) molecular weight amongst individual polymer chains (i.e., a polydispersity index of less than 3); and (ii) monomer residue distribution (in the case of copolymers) amongst individual polymer chains. As such, in contrast to heterogeneous polyolefins, homogeneous polyolefins have similar chain lengths amongst individual polymer chains, a relatively even distribution of monomer residues along polymer chain backbones, and a relatively similar distribution of monomer residues amongst individual polymer chain backbones. Homogeneous polyolefins are typically prepared by means of single-site, metallocene or constrained-geometry catalysis. The monomer residue distribution of homogeneous polyolefin copolymers may be characterized by composition distribution breadth index (CDBI) values, which are defined as the weight percent of polymer molecules having a comonomer residue content within 50 percent of the median total molar comonomer content. As such, a polyolefin homopolymer has a CDBI value of 100 percent. For example, homogenous polyethylene/alpha-olefin copolymers typically have CDBI values of greater than 60 percent or greater than 70 percent. Composition distribution breadth index values may be determined by art recognized methods, for example, temperature rising elution fractionation (TREF), as described by Wild et al, Journal of Polymer Science, Poly. Phys. Ed., Vol. 20, p. 441 (1982), or in U.S. Pat. No. 4,798,081, or in U.S. Pat. No. 5,089,321.

In an embodiment of the present invention, the polyolefin is a polyethylene. In accordance with the description provided herein with regard to the term “polyolefin”, the term “polyethylene” means polyethylene homopolymers, polyethylene copolymers, homogeneous polyethylenes, heterogeneous polyethylenes; blends of two or more such polyethylenes thereof; and blends of polyethylene with another polymer (e.g., polypropylene).

Polyethylene copolymers that may be used in the present invention typically include: at least 50 weight percent, and more typically at least 70 weight percent of ethylene monomer residues; and less than or equal to 50 weight percent, and more typically less than or equal to 30 weight percent of non-ethylene comonomer residues (e.g., vinyl acetate monomer residues). The weight percents in each case being based on total weight of monomer residues. Polyethylene copolymers may be prepared from ethylene and any monomer that is copolymerizable with ethylene. Examples of monomers that are copolymerizable with ethylene include, but are not limited to, C₃-C₁₂ alpha-olefins, such as 1-butene, 1-hexene and/or 1-octene; vinyl acetate; vinyl chloride; (meth)acrylic acid; and esters of (meth)acrylic acid.

Polyethylene blends that may be used in the present invention typically include: at least 50 percent by weight, and more typically at least 60 percent by weight of polyethylene polymer (e.g., polyethylene homopolymer and/or copolymer); and less than or equal to 50 percent by weight, and more typically less than or equal to 40 percent by weight of another polymer, that is different than the polyethylene polymer (e.g., polypropylene). The weight percents in each case being based on total polymer blend weight. Polyethylene blends may be prepared from polyethylene and any other polymer that is compatible therewith. Examples of polymers that may be blended with polyethylene include, but are not limited to, polypropylene, polybutadiene, polyisoprene, polychloroprene, chlorinated polyethylene, polyvinyl chloride, styrene-butadiene copolymers, vinyl acetate-ethylene copolymers, acrylonitrile-butadiene copolymers, vinyl chloride-vinyl acetate copolymers, and combinations thereof.

In an embodiment of the present invention, the polyethylene polymer is selected from: low density polyethylene; medium density polyethylene; high density polyethylene; a copolymer of ethylene and vinyl acetate; a copolymer of ethylene and butyl acrylate; a copolymer of ethylene and methyl methacrylate; a blend of polyethylene and polypropylene; a blend of polyethylene and a copolymer of ethylene and vinyl acetate; and a blend of polyethylene and a copolymer of ethylene and propylene.

In a particular embodiment, the polyolefin polymer is prepared from an olefin monomer composition that includes ethylene monomer, and optionally a comonomer selected from alpha-olefin monomer other than ethylene, such as C₃-C₈-alpha-olefin monomer (e.g., propylene and/or butylene), vinyl acetate, C₁-C₂₀-(meth)acrylate, such as C₁-C₈-(meth)acrylate, and combinations thereof. Typically, ethylene monomer is present in the olefin monomer composition in an amount of at least 50 percent by weight, based on total weight of the olefin monomer composition.

In a further embodiment of the present invention, the polyolefin polymer is prepared from an olefin monomer composition that includes ethylene monomer (e.g., at least 50 percent by weight ethylene monomer, based on total weight of the olefin monomer composition), and vinyl acetate. More particularly, the polyolefin polymer is a polyethylene polymer, which is a copolymer of ethylene and vinyl acetate containing ethylene monomer residues in an amount of from 75 weight percent to 99 weight percent, and vinyl acetate monomer residues in an amount of from 1 weight percent to 25 weight percent. The weight percents in each case being based on total weight of monomer residues. In a particular embodiment, the polyolefin polymer is a polyethylene polymer, which is a copolymer of ethylene and vinyl acetate containing 95 percent by weight of ethylene monomer residues, and 5 percent by weight of vinyl acetate monomer residues, based in each case on total weight of monomer residues. As used herein and in the claims, the percent weight monomer residue values are substantially equivalent to the percent weight of corresponding monomers present within the olefin monomer composition from which the polyolefin polymer is prepared.

The polyolefin polymer is typically present in the particulate interpenetrating network polymer in an amount of less than or equal to 80 percent by weight, more typically less than or equal to 65 percent by weight, and further typically less than or equal to 50 percent by weight, based on total weight of the particulate interpenetrating network polymer. The polyolefin polymer is typically present in the particulate interpenetrating network polymer in an amount equal to or greater than 10 percent by weight, more typically equal to or greater than 15 percent weight, and further typically equal to or greater than 20 percent by weight, based on total weight of the particulate interpenetrating network polymer. The amount of polyolefin polymer present in the particulate interpenetrating network polymer of the present invention may range between any combination of these upper and lower values, inclusive of the recited values. For example, the polyolefin polymer may be present in the particulate interpenetrating network polymer in an amount of from 10 to 80 percent by weight, more typically from 15 to 65 percent by weight, and further typically from 20 to 50 percent by weight, based on total weight of the particulate interpenetrating network polymer.

The expandable particulate interpenetrating network polymer of the present invention also includes a vinyl aromatic polymer. As used herein and in the claims, the term “vinyl aromatic polymer” means one or more vinyl aromatic homopolymers, one or more vinyl aromatic copolymers and blends thereof.

The vinyl aromatic polymer may be prepared from one or more vinyl aromatic monomers, and optionally at least one comonomer that is not a vinyl aromatic monomer. In an embodiment, the vinyl aromatic polymer is prepared from a vinyl aromatic polymer monomer composition that includes: (i) a vinyl aromatic monomer present in an amount of from 70 percent by weight to 99 percent by weight (or 90 to 98 percent by weight, or 92.5 to 97.5 percent by weight), based on total weight of the vinyl aromatic polymer monomer composition; and (ii) a comonomer present in an amount of from 1 percent by weight to 30 percent by weight (or 2 to 10 percent by weight, or 2.5 to 7.5 percent by weight), based on total weight of the vinyl aromatic polymer monomer composition.

Vinyl aromatic monomers that may be used to prepare the vinyl aromatic polymer of the present invention include those known to the skilled artisan. In an embodiment, the vinyl aromatic monomer is selected from styrene, alpha-methylstyrene, para-methylstyrene, ethylstyrene, chlorostyrene, bromostyrene, vinyltoluene, vinylbenzene, isopropylxylene and combinations thereof.

Comonomers that may be polymerized with the vinyl aromatic monomer(s) to form the vinyl aromatic polymer of the present invention, include those known to the skilled artisan. Examples of suitable comonomers include, but are not limited to: (meth)acrylates, such as C₁-C₂₀- or C₁-C₈-(meth)acrylates (e.g., butyl acrylate, ethyl acrylate, 2-ethylhexyl acrylate, methyl methacrylate, ethyl methacrylate, butyl methacrylate, and 2-ethylhexyl methacrylate); acrylonitrile; vinyl acetate; dialkyl maleates (e.g., dimethyl maleate and diethyl maleate); and maleic anhydride. The comonomer may also be selected from multi-ethylenically unsaturated monomers, such as dienes (e.g., 1,3-butadiene); di-(meth)acrylates of alkyleneglycols having one or more alkyleneglycol repeat units (e.g., ethyleneglycol di-(meth)acrylate, diethyleneglycol di-(meth)acrylate, and poly(ethyleneglycol) di-(meth)acrylate having 3 or more ethyleneglycol repeat units, such as 3 to 100 repeat units); trimethylolpropane di- and tri-(meth)acrylate; pentaerythritol di-, tri- and tetra-(meth)acrylate; and divinyl benzene. Multi-ethylenically unsaturated monomers are typically present in the vinyl aromatic polymer monomer composition in amounts of less than or equal to 5 percent by weight, and more typically less than or equal to 3 percent by weight, (e.g., from 0.5 to 1.5 or 2 percent by weight) based on total weight of the vinyl aromatic polymer monomer composition.

In an embodiment, the vinyl aromatic polymer is prepared from a vinyl aromatic polymer monomer composition that includes vinyl aromatic monomer (e.g., styrene) and at least one C₁-C₂₀-(meth)acrylate, such as at least one C₁-C₈-(meth)acrylate (e.g., butyl(meth)acrylate). In a particular embodiment, the vinyl aromatic polymer is prepared from a vinyl aromatic polymer monomer composition that includes styrene and butyl acrylate (e.g., 97 percent by weight styrene, and 3 percent by weight butyl acrylate, based on total monomer weight in each case).

The vinyl aromatic polymer is typically present in the particulate interpenetrating network polymer in an amount of less than or equal to 90 percent by weight, more typically less than or equal to 85 percent by weight, and further typically less than or equal to 80 percent by weight, based on total weight of the particulate interpenetrating network polymer. The vinyl aromatic polymer is typically present in the particulate interpenetrating network polymer in an amount equal to or greater than 20 percent by weight, more typically equal to or greater than 35 percent weight, and further typically equal to or greater than 50 percent by weight, based on total weight of the particulate interpenetrating network polymer. The amount of vinyl aromatic polymer present in the particulate interpenetrating network polymer of the present invention may range between any combination of these upper and lower values, inclusive of the recited values. For example, the vinyl aromatic polymer may be present in the particulate interpenetrating network polymer in an amount of from 20 to 90 percent by weight, more typically from 35 to 85 percent by weight, and further typically from 50 to 80 percent by weight, based on total weight of the particulate interpenetrating network polymer.

The polyolefin polymer (e.g., a copolymer of ethylene and vinyl acetate) and the vinyl aromatic polymer (e.g., a copolymer of styrene and butyl acrylate) together form the particulate interpenetrating network polymer of the expandable particulate interpenetrating network polymer of the present invention. Typically, the interpenetrating network polymer is prepared by polymerizing the vinyl aromatic polymer monomer composition substantially within previously formed/polymerized polyolefin particles. In general, polyolefin particles are infused or impregnated with the vinyl aromatic polymer monomer composition and one or more initiators, such as peroxide initiators. The vinyl aromatic polymer monomer composition is then polymerized. Based on the evidence at hand, and without intending to be bound by any theory, it is believed that polymerization of the vinyl aromatic polymer monomer composition occurs substantially within the polyolefin particles.

In an embodiment of the present invention, the expandable particulate interpenetrating network polymer is prepared by a process comprising: (a) providing the polyolefin polymer in the form of a particulate polyolefin polymer; and (b) polymerizing the vinyl aromatic polymer monomer composition substantially within the particulate polyolefin polymer.

Formation of the particulate interpenetrating network polymer may be conducted under aqueous or non-aqueous conditions (e.g., in the presence of an organic medium). Typically, formation of the particulate interpenetrating network polymer is conducted under aqueous conditions.

When conducted under aqueous conditions, the polyolefin particles are typically first suspended in a combination of water (e.g., deionized water) and suspension agents. Numerous suspension agents that are known to the skilled artisan may be employed. Classes of suspension agents that may be used to form the interpenetrating network polymer of the present invention, include, but are not limited to: water soluble high molecular weight materials (e.g., polyvinyl alcohol, methyl cellulose, hydroxyl ethyl cellulose, and polyvinylpyrrilodone); slightly or marginally water soluble inorganic materials (e.g., calcium phosphate, magnesium pyrophosphate, and calcium carbonate); and sulfonates, such as sodium dodecylbenzene sulfonate. In an embodiment, a combination of tricalcium phosphate and sodium dodecylbenzene sulfonate is used together as suspension agents in the preparation of the particulate interpenetrating network polymer.

The suspension agent may be present in an amount so as to effect suspension of the polyolefin particles within the aqueous medium. Typically, the suspension agent is present in an amount of from 0.01 to 5 percent by weight, and more typically from 1 to 3 percent by weight, based on the total weight of the water and suspension agent(s).

The polyolefin particles are generally added, with agitation, to a previously formed water and suspension agent composition. Alternatively, the polyolefin particles, water and suspension agent may be concurrently mixed together. The amount of water present, relative to the amount of polyolefin particles may vary widely. Enough water is present for purposes of effectively suspending the polyolefin particles, and allowing for the addition, infusion and polymerization of the vinyl aromatic polymer monomer composition. Typically, the weight ratio of water to polyolefin particles is from 0.7:1 to 5:1, and more typically from 3:1 to 5:1.

The weight ratio of water to particulate polymer material may change during the process of forming the particulate interpenetrating network polymer. For example, the weight ratio of water to polyolefin particles may initially be 5:1, and with the introduction and polymerization of the vinyl aromatic polymer monomer composition over time, the weight ratio of water to the forming/formed particulate interpenetrating network polymer may be effectively and correspondingly reduced (e.g., to 1:1).

The vinyl aromatic polymer monomer composition and initiators are typically next added to the aqueous suspension of particulate polyolefin. The initiator may be added pre-mixed with the vinyl aromatic polymer monomer composition, concurrently therewith, and/or subsequently thereto. If added separately from the vinyl aromatic polymer monomer composition, the initiators may be added alone or dissolved in an organic solvent, such as toluene or 1,2-dichloropropane, as is known to the skilled artisan. Typically, the initiator is pre-mixed with (e.g., dissolved into) the vinyl aromatic polymer monomer composition, and the mixture thereof is added to the aqueous suspension of polyolefin particles.

One or more initiators suitable for polymerizing the vinyl aromatic polymer monomer composition may be used. Examples of suitable initiators include, but are not limited to: organic peroxides, such as benzoyl peroxide, lauroyl peroxide, t-butyl perbenzoate, and t-butyl peroxypivalate; and azo compounds, such as azobisisobutylonitrile and azobisdimethylvaleronitrile.

Polymerization of the vinyl aromatic polymer monomer composition may also be conducted in the presence of chain transfer agents, which serve to control the molecular weight of the resulting vinyl aromatic polymer. Examples of chain transfer agents that may be used include, but are not limited to: C₂₋₁₅ alkyl mercaptans, such as n-dodecyl mercaptan, t-dodecyl mercaptan, t-butyl mercaptan, and n-butyl mercaptan; and alpha methyl styrene dimer.

The initiator is generally present in an amount at least sufficient to polymerize substantially all of the monomers of the vinyl aromatic polymer monomer composition. Typically, the initiator is present in an amount of from 0.05 to 2 percent by weight, and more typically from 0.1 to 1 percent by weight, based on the total weight of vinyl aromatic polymer monomer composition and initiator.

Polymerization of the vinyl aromatic polymer monomer composition within the polyolefin particles generally involves the introduction of heat into the reaction mixture. For example, the contents of the reactor may be heated to temperatures of from 60° to 120° for a period of at least one hour (e.g., 8 to 20 hours) in a closed vessel (or reactor) under an inert atmosphere (e.g., a nitrogen sweep), in accordance with art-recognized procedures. Upon completion of the polymerization, work-up procedures may include the introduction of one or more washing agents (e.g., inorganic acids), and separation of the particulate interpenetrating network polymer from the aqueous reaction medium (e.g., by means of centrifuging), in accordance with art-recognized methods.

The particulate polyolefin may be crosslinked in an embodiment of the present invention. Crosslinking of the particulate polyolefin polymer may be achieved during polymerization and formation of the polyolefin particles, and/or during polymerization of the vinyl aromatic polymer monomer composition within the polyolefin particles. Crosslinking of the particulate polyolefin polymer during formation thereof, may be achieved by the use of multi-functional initiators and/or multi-ethylenically unsaturated monomers, in accordance with art-recognized methods and materials.

In an embodiment, the particulate polyolefin polymer is crosslinked concurrently with the polymerization of the vinyl aromatic polymer monomer composition within the polyolefin particles. Typically, when performed concurrently with the polymerization of the vinyl aromatic polymer monomer composition, crosslinking of the polyolefin particles is achieved by means of cross-linking agents selected from certain organic peroxide materials. Examples of suitable crosslinking agents include, but are not limited to: di-t-butyl-peroxide, t-butyl-cumylperoxide, dicumyl-peroxide, α,α-bis-(t-butylperoxy)-p-diisopropylbenzene, 2,5-dimethyl-2,5-di-(t-butylperoxy)-hexyne-3,2,5-dimethyl-2,5-di-(benzoylperoxy)-hexane, t-butyl-peroxyisopropyl-carbonate; multi-functional organic peroxide materials, such as polyether poly(t-butyl peroxycarbonate), commercially available under the tradename LUPEROX JWEB50; and combinations thereof.

The crosslinking agents may be introduced as part of the vinyl aromatic polymer monomer composition, and/or separately from the vinyl aromatic polymer monomer composition (e.g., prior to, concurrently with, and/or subsequently thereto). Typically, the crosslinking agents are mixed with (e.g., dissolved into/with) the vinyl aromatic polymer monomer composition. The crosslinking agents are generally present in an amount of from 0.1 to 2 percent by weight, and typically from 0.5 to 1 percent by weight, based on the weight of polyolefin particles.

The intermediate particulate interpenetrating network polymer (prior to impregnation with expansion agent) may have a wide range of particle sizes and shapes. Typically, the particulate interpenetrating network polymer has an average particle size (as determined along the longest particle dimension) of from 0.2 to 2.0 mm, more typically from 0.8 to 1.5 mm, and further typically from 1.0 to 1.2 mm. The particulate interpenetrating network polymer may have shapes selected from spherical shapes, oblong shapes, rod-like shapes, irregular shapes and combinations thereof. More typically, the particulate interpenetrating network polymer has shapes selected from spherical shapes and/or oblong shapes. The particulate interpenetrating network polymer may have an aspect ratio of from 1:1 to 4:1 (e.g., from 1:1 to 2:1).

At one or more points throughout the formation of the particulate interpenetrating network polymer, the expansion agent may be introduced therein, so as to form the expandable particulate interpenetrating network polymer of the present invention. For example, the expansion agent may be introduced into the particulate interpenetrating network polymer: concurrently with polymerization of the vinyl aromatic polymer monomer composition; before crosslinking of the polyethylene particles is undertaken; after completion of the polymerization and crosslinking steps, and prior to the work-up step; and/or after the work-up step. The impregnation process may be performed in the same vessel in which the vinyl aromatic monomer polymerization is performed, and/or a separate vessel.

Typically, after work-up of the particulate interpenetrating network polymer (e.g., by the addition of washing agents, and separation from the aqueous reaction medium), the expansion agent is introduced into the particulate interpenetrating network polymer so as to form the expandable particulate interpenetrating network polymer of the present invention. The expansion agent of the expandable particulate interpenetrating network polymer of the present invention consists or consists essentially of pentafluorobutane, and optionally a minor amount of heptafluoropropane (i.e., less than or equal to 49 percent by weight of heptafluoropropane, based on total weight of pentafluorobutane and heptafluoropropane).

The expansion agent is typically present in the expandable particulate interpenetrating network polymer in an amount of less than or equal to 20 percent by weight, more typically less than or equal to 15 percent by weight, and further typically less than or equal to 12 percent by weight, based on the total weight of the expandable particulate interpenetrating network polymer (including the weight of the expansion agent). The expansion agent is typically present in the expandable particulate interpenetrating network polymer in an amount equal to or greater than 1 percent by weight, more typically equal to or greater than 1.5 percent by weight, and further typically equal to or greater than 3 percent by weight, based on the total weight of the expandable particulate interpenetrating network polymer (including the weight of the expansion agent). The amount of expansion agent present in the expandable particulate interpenetrating network polymer of the present invention may range between any combination of these upper and lower values, inclusive of the recited values. For example, the expansion agent may be present in the expandable particulate interpenetrating network polymer of the present invention in an amount of from 1 or 1.5 percent by weight to 20 percent by weight, more typically from 1.5 percent by weight to 15 percent by weight, and further typically from 3 percent by weight to 12 percent by weight, based on the total weight of the expandable particulate interpenetrating network polymer (including the weight of the expansion agent, and inclusive of the recited values).

When the expansion agent includes both pentafluorobutane and heptafluoropropane, the pentafluorobutane is present in a major amount (i.e., greater than or equal to 51 percent by weight pentafluorobutane, based on total weight of pentafluorobutane and heptafluoropropane), and the heptafluoropropane is present in a minor amount (i.e., less than or equal to 49 percent by weight of heptafluoropropane, based on total weight of pentafluorobutane and heptafluoropropane). More particularly, when the expansion agent includes both pentafluorobutane and heptafluoropropane, the pentafluorobutane may be present in an amount of from 51 percent by weight to 99 percent by weight, typically from 60 percent by weight to 99 percent by weight, more typically from 70 percent by weight to 99 percent by weight, and further typically from 85 percent by weight to 99 percent by weight, based on total weight of pentafluorobutane and heptafluoropropane, inclusive of the recited values. When the expansion agent consists of both pentafluorobutane and heptafluoropropane, the heptafluoropropane may be present in an amount of from 1 percent by weight to 49 percent by weight, typically from 1 percent by weight to 40 percent by weight, more typically from 1 percent by weight to 30 percent by weight, and further typically from 1 percent by weight to 15 percent by weight, based on total weight of pentafluorobutane and heptafluoropropane, inclusive of the recited values.

The pentafluorobutane and heptafluoropropane may each independently be selected from one or more structural isomers thereof. In an embodiment of the present invention, the pentafluorobutane is 1,1,1,3,3-pentafluorobutane, and the heptafluoropropane is 1,1,1,2,3,3,3-heptafluoropropane. The expansion agent, in an embodiment, includes or consists essentially of a major amount of 1,1,1,3,3-pentafluorobutane, and a minor amount of 1,1,1,2,3,3,3-heptafluoropropane, the major and minor amounts being selected from those amounts and ranges as recited previously herein with regard to pentafluorobutane and heptafluoropropane. For example, the expansion agent may include or consist essentially of 1,1,1,3,3-pentafluorobutane present in an amount of 85 to 99 percent by weight (e.g., 87 or 93 percent by weight), based on total weight of the expansion agent, and 1,1,1,2,3,3,3-heptafluoropropane present in an amount of 1 to 15 percent by weight (e.g., 13 or 7 percent by weight), based on total weight of the expansion agent. In an embodiment, the expansion agent consists or consists essentially of 1,1,1,3,3-pentafluorobutane alone in the absence of 1,1,1,2,3,3,3-heptafluoropropane or any other expansion agent.

The expansion agent is typically introduced into the particulate interpenetrating network polymer under conditions of elevated pressure and temperature. The expansion agent may be introduced into the particulate interpenetrating network polymer in the presence or absence of a liquid suspending-medium (e.g., water and/or organic solvent). For example, the particulate interpenetrating network polymer may be dispersed in the expansion agent alone, in the absence of a separate liquid suspending medium (e.g., in the absence of water), and exposed to elevated temperature and pressure.

When the particulate interpenetrating network polymer is impregnated with the expansion agent in the absence of a liquid suspending medium, a dry (or anhydrous) impregnation process may be employed. For example, the blowing agent may be introduced into a fluidized bed of the particulate interpenetrating network polymer (optionally formed within a rotating vessel), under conditions of elevated temperature (e.g., from greater than 25° C. to 70° C., or 50° C. to 60° C.).

Typically, the expansion agent is impregnated into the particulate interpenetrating network polymer in the presence of a liquid medium, and in particular in the presence of water under aqueous conditions. In particular, a suspension of particulate interpenetrating network polymer material in water and suspension agent is formed in a closed vessel. The suspension agent may be selected from those classes and examples recited previously herein with regard to formation of the particulate interpenetrating network polymer. The expansion agent is then introduced into the vessel with agitation, under an inert atmosphere (e.g., a nitrogen sweep). The temperature of the contents of the vessel is elevated (e.g., from 40° C. to 120° C.), and held for a period of time sufficient to result in infusion (or impregnation) of the expansion agent into the particulate interpenetrating network polymer (e.g., from 4 to 8 hours). The particulate interpenetrating network polymer impregnated with expansion agent (i.e., the expandable particulate interpenetrating network polymer) is then separated from the aqueous impregnation medium (e.g., by centrifuging).

The expandable particulate interpenetrating network polymer (after impregnation with expansion agent) may have a wide range of particle sizes and shapes. Typically, the expandable particulate interpenetrating network polymer of the present invention has shapes and particle size ranges that are substantially similar to those of the intermediate particulate interpenetrating network polymer (prior to impregnation with expansion agent). For example, the expandable particulate interpenetrating network polymer typically has an average particle size (as determined along the longest particle dimension) of from 0.2 to 2.0 mm, more typically from 0.8 to 1.5 mm, and further typically from 1.0 to 1.2 mm. The expandable particulate interpenetrating network polymer may have shapes selected from spherical shapes, oblong shapes, rod-like shapes, irregular shapes and combinations thereof. More typically, the expandable particulate interpenetrating network polymer has shapes selected from spherical shapes and/or oblong shapes. The expandable particulate interpenetrating network polymer may have an aspect ratio of from 1:1 to4:1 (e.g., from 1:1 to2:1).

Upon storage, the expandable particulate interpenetrating network polymer typically loses some of the expansion agent therefrom. While not intending to be bound by any theory, and based on the evidence presently at hand, it is believed that expansion agent is lost from the expandable particulate interpenetrating network polymer by diffusion of the expansion agent out of the particles. If too much expansion agent is lost, the particulate interpenetrating network polymer will not be sufficiently expandable. As such, the expandable particulate interpenetrating network polymer of the present invention may be characterized with regard to expansion agent retention values. The expansion agent retention values indicate the amount of expansion agent still retained within the expandable particulate interpenetrating network polymer material after storage for a certain period of time, and under certain specified conditions. The expansion agent retention values are expressed as percent weight values, and are based on the weight of expansion agent originally or initially present within the expandable particulate material. As such, expansion agent retention values of larger magnitude are desirable, while expansion agent retention values of lesser magnitude are undesirable.

The amount of expansion agent lost as a function of time may be reduced or minimized by storing the expandable particulate interpenetrating network polymer material at reduced temperature (e.g., at temperatures of from 5° C. to 15° C.) and/or in sealed containers. As discussed previously, such additional measures typically result in increased storage and/or shipping costs. Accordingly, reducing the amount of expansion agent lost from the expandable particulate material under ambient conditions is desirable.

Generally, expansion agent retention values of greater than or equal to 50 percent by weight, based on original weight of the expansion agent, are desirable. Expansion agent retention values of less than 50 percent by weight, for example, less than or equal to 40 percent by weight, and, in particular, less than or equal to 30 percent by weight are undesirable, since the particulate interpenetrating network polymer material may not be sufficiently expandable, and as such may not be used to prepare expanded particulate molded articles having desirable physical properties, such as high impact resistance and low density.

In an embodiment, the expandable particulate interpenetrating network polymer of the present invention has an expansion agent retention value of at least 50 percent by weight, based on original weight of the expansion agent. In a further embodiment, the expandable particulate interpenetrating network polymer of the present invention has an expansion agent retention value of at least 60 percent by weight, based on original weight of the expansion agent. While the upper limit of the expansion agent retention values is 100 percent by weight, the expandable particulate interpenetrating network polymer of the present invention typically has expansion agent retention values of less than 100 percent, for example, less than or equal to 90 percent by weight, less than or equal to 80 percent by weight or less than or equal to 70 percent by weight, based on original weight of the expansion agent (since some expansion agent usually is lost from the expandable particulate interpenetrating network polymer over time). The expansion agent retention values of the expandable particulate interpenetrating network polymer of the present invention may range between any combination of these upper and lower values, inclusive of the recited values. For example, the expandable particulate interpenetrating network polymer of the present invention may have expansion agent retention values of from 50 percent by weight to less than 100 percent by weight, or from 50 to 90 percent by weight, or from 60 to 80 percent by weight, or from 60 to 70 percent by weight, based on original weight of the expansion agent (inclusive of the recited values).

The expansion agent retention values are determined by exposing a single layer of expandable particulate interpenetrating network polymer, in an open container (e.g., a tray), to conditions of: a temperature of about 25° C. (e.g., 25° C.±2° C.); a pressure of about 1 atmosphere (e.g., 1 atm±0.2 atm); and a period of 7 days (e.g., 168 hours). As used herein and in the claims, the “expansion agent retention value(s)” are further determined and defined in accordance with the description provided in the Examples herein, under the heading of “Expansion Agent Retention Evaluation.”

The expandable particulate interpenetrating network polymer of the present invention may optionally further include plasticizers, such as toluene, ethylbenzene and/or limonene. A particularly preferred plasticizer is limonene. While not intending to be bound by any theory, and based on the evidence presently at hand, it is believed that the limonene material, in addition or alternatively to acting at least to some extent as a plasticizer, may also act as an expansion agent within the expandable particulate interpenetrating network polymer of the present invention. The limonene material may be selected from d-limonene, l-limonene, d/l-limonene or combinations thereof. In an embodiment, the limonene material is selected from d-limonene. The limonene material is typically present in an amount of from 0.1 to 5 percent by weight, and more typically from 0.1 to 1 percent by weight, based on the total weight of expandable particulate interpenetrating network polymer (including the weight of limonene).

The limonene material may be introduced into the particulate interpenetrating network polymer prior to, concurrently with, or subsequent to the introduction/impregnation of the expansion agent. The limonene material is usually introduced into the particulate interpenetrating network polymer concurrently with the expansion agent. For example, limonene and the expansion agent (e.g., composed of 1,1,1,3,3-pentafluorobutane, and optionally 1,1,1,2,3,3,3-heptafluoropropane) may be previously mixed together, and then together introduced into the particulate interpenetrating network polymer during the impregnation process, as described previously herein.

The expandable particulate interpenetrating network polymer of the present invention may optionally include additives. Examples of additives include, but are not limited to: colorants (e.g., dyes and/or pigments); ultraviolet light absorbers; antioxidants; antistatic agents; fire retardants; fillers (e.g., clays); and nucleating agents, typically in the form of waxes (e.g., polyolefin waxes, such as polyethylene waxes). Additives may be present in the expandable particulate interpenetrating network polymer in functionally sufficient amounts, e.g., in amounts independently from 0.1 percent by weight to 10 percent by weight, based on the total weight of the expandable particulate interpenetrating network polymer. The additives may be introduced at any point during formation of the expandable particulate interpenetrating network polymer, or any component thereof. For example, at least some of the additives may be introduced into the polyolefin polymer during its polymerization, and/or after polymerization by melt blending (e.g., extrusion). Alternatively, at least some of the additives may be introduced during polymerization of the vinyl aromatic polymer monomer composition. Further alternatively, at least some of the additives may be introduced after formation of the particulate interpenetrating network polymer and prior to impregnation thereof with expansion agent, and/or concurrently with the impregnation process.

The expandable particulate interpenetrating network polymers of the present invention may be used to prepare molded articles comprising expanded particulate interpenetrating network polymers. Generally, the expandable particulate interpenetrating network polymer material is introduced into an expander, and exposed to elevated temperature (e.g., by passing steam through the expander). Upon exposure to elevated temperatures, the expansion agent causes the particulate interpenetrating network polymer material to expand. After an optional storage or aging period, the expanded interpenetrating network polymer material is introduced into a mold where it is exposed to elevated temperature and pressure. Abutting portions of the surfaces of the expanded interpenetrating network polymer material fuse together, and residual expansion agent, if any, is vented from the mold. The expansion agent may be captured from the expander and mold, isolated and reused or pyrolyzed, or it may be allowed to vent to the atmosphere. The molded article is then removed from the mold, and may be used as is, or subjected to post-molding operations, such as cutting, sanding, and shaping.

Examples of molded articles that may be prepared from the expandable particulate interpenetrating network polymers of the present invention include, but are not limited to: containers, such as shipping containers and food containers; cushion or impact elements used in packaging assemblies; floatation devices; and cores of architectural panels (e.g., doors, walls, dividers and bulkheads) and recreational articles, such as surf boards. For purposes of illustration, a packaging assembly may include a box, such as a cardboard box, having cushion elements, fabricated from the expandable particulate interpenetrating network polymers of the present invention, retained therein. The cushion elements may be dimensioned to receive a portion of a ware (e.g., a flat screen TV) therein, thereby protecting the ware from impacts during shipping that would otherwise result in damage to the ware.

The present invention is more particularly described in the following examples, which are intended to be illustrative only, since numerous modifications and variations therein will be apparent to those skilled in the art. Unless otherwise specified, all parts and all percentages are by weight.

### EXAMPLES

### Example A

The particulate interpenetrating network polymers used in the expansion examples, as described further herein, were prepared in accordance with the following description.

Material

Charge 1

| | Amount | |
|---|---|---|
| Deionized water | 199.2 | Kg |
| Tricalcium phosphate | 4.5 | Kg |
| Sodium dodecylbenzene sulfonate | 69.2 | g |

Charge 2

| | | |
|---|---|---|
| PE resin particles⁽¹⁾ | 39.5 | Kg |

Charge 3

| | | |
|---|---|---|
| Styrene | 87.7 | Kg |
| Butyl acrylate | 4.1 | Kg |
| Dicumylperoxide | 309.7 | g |
| Benzoylperoxide | 150 | g |
| Tert-butyl perbenzoate | 15.4 | g |

Charge 4

| | |
|---|---|
| | Comment |
| Hydrochloric acid⁽²⁾ | To a pH of 1.8. |

⁽¹⁾PETROTHENE NA 480-177 low density polyethylene/vinyl acetate copolymer (95.5percent by weight ethylene, and 4.5 percent by weight vinyl acetate) resin particles obtained commercially from Equistar Chemicals (a wholly owned subsidiary of Lyondell Chemical Company) having: a Melt Index of 0.3 g/10 minutes; density of 0.923 g/cm³; and a Vicat softening point of 42.8° C. (109° F.).
⁽²⁾10.3-11.5 molar hydrochloric acid.

Charge 1 was added to an empty 454.6 liter (100 gallon) stainless steel reactor having a temperature controllable jacket, a motor driven impeller, a nitrogen sweep, and at least one feed port. While under a nitrogen sweep and with constant stirring provided by the impeller turning at 86 revolutions per minute, the reactor contents were raised to a temperature of 85° C.

Charge 2 was then added to the contents of the reactor with constant stirring.

Charge 3 was added drop-wise to the reactor over a period of 4.4 hours, with constant stirring (provided by the impeller turning at 86 revolutions per minute), under a nitrogen sweep, and while maintaining the contents of the reactor at a temperature of 85° C. Upon completing the addition of Charge 3, the contents of the reactor were raised to a temperature of 143° C. over a period of 153 minutes, followed by a hold at 143° C. for 2.5 hours, with constant stirring and nitrogen sweep.

After completion of the 2.5 hour hold at 143° C., the contents of the reactor were cooled to ambient temperature (of approximately 25° C.), and discharged to a downstream wash vessel (or kettle) where Charge 4 was added until the contents had a pH value of 1.8. Typically, approximately 8.2 to 11.5 liters of Charge 4 are added to achieve a pH value of 1.8.

The contents of the reactor were then transferred to and dewatered by spinning in a centrifuge. The dried interpenetrating network polymer particles were retrieved from the centrifuge and then screened to remove particles having: an average diameter of less than 0.869 mm; and an average particle size of greater than 2.449 mm. The dried and screened interpenetrating network polymer particles were used to prepare the expandable particulate interpenetrating network polymers of the following examples.

### Example 1

A comparative impregnated particulate interpenetrating network polymer material was prepared in accordance with the following description. CALSOFT F90 sodium dodecyl benzene sulfonate (obtained commercially from Pilot Chemical Corporation) was added in an amount of 0.04 grams to a 2 liter stainless steel vessel having a temperature controllable jacket, a motor driven impeller, a nitrogen blanket, and at least one feed port, containing 887 grams of deionized water. With constant stirring at ambient temperature, 814 grams of particulate interpenetrating network polymer of Example A were added to the vessel. The vessel was closed, and the contents thereof were stirred at a rate of 700 rpm at ambient temperature under a nitrogen blanket.

A composition composed of 2.9 grams d-limonene (obtained commercially from Florida Chemical Company and having a purity of 95% by weight), and 99.3 grams of isopentane (as an expansion agent) was introduced into the vessel at a rate of 10 ml/minute, as the contents of the vessel were heated to a temperature of 70° C. with constant stirring. It took approximately 18 minutes for the contents of the vessel to reach a temperature of 70° C. The contents of the vessel (including the addition of isopentane and d-limonene) were then held at 70° C. with constant stirring under a nitrogen blanket for 1.5 hours, after which the contents of the vessel were cooled to room temperature. The comparative impregnated particulate interpenetrating network polymer material was removed from the vessel and dewatered in a centrifuge. Physical properties and test results of the impregnated particulate interpenetrating network polymer material of this example are summarized in Tables 1, 2 and 3.

### Examples 2-4

Impregnated, and accordingly expandable, particulate interpenetrating network polymer materials according to the present invention were prepared in accordance with the following description. CALSOFT F90 sodium dodecyl benzene sulfonate (obtained commercially from Pilot Chemical Corporation) was added in an amount of 0.04 grams to a 2 liter stainless steel vessel having a temperature controllable jacket, a motor driven impeller, a nitrogen blanket, and at least one feed port, containing 887 grams of deionized water. With constant stirring at ambient temperature, 814 grams of particulate interpenetrating network polymer of Example A were added to the vessel. The vessel was closed, and the contents thereof were stirred at a rate of 700 rpm at ambient temperature under a nitrogen blanket, and were heated to 60° C. at a rate of 4.5° C./minute.

A composition composed of 2.9 grams d-limonene (obtained commercially from Florida Chemical Company and having a purity of 95% by weight), and 101.9 grams of 1,1,1,3,3-pentafluorobutane and optionally 1,1,1,2,3,3,3-heptafluoropropane (as expansion agents) was introduced into the vessel at a rate of 4.6 ml/minute. In the case of 1,1,1,3,3-pentafluorobutane alone (Example 2), the contents of the vessel were heated, during addition, to a temperature of 95° C. with constant stirring. In the case of blends of 1,1,1,3,3-pentafluorobutane and 1,1,1,2,3,3,3-heptafluoropropane (Examples 3 and 4), the contents of the vessel were heated, during addition, to a temperature of 85° C. with constant stirring. The weight ratio of 1,1,1,3,3-pentafluorobutane and 1,1,1,2,3,3,3-heptafluoropropane is recited in Table 1. In the case of Example-2, it took approximately 15 minutes for the contents of the vessel to reach a temperature of 95° C. In the case of Examples 3 and 4, it took approximately 10 minutes for the contents of the vessel to reach a temperature of 85°. The contents of the vessel (including the addition of d-limonene, pentafluorobutane and optionally heptafluoropropane) were then held at 95° C. in the case of Example 2, and 85° C. in the case of Examples 3 and 4, with constant stirring under a nitrogen blanket for 6 hours, after which the contents of the vessel were cooled to room temperature. The impregnated particulate interpenetrating network polymer materials according to the present invention were removed from the vessel and dewatered in a centrifuge. Physical properties and test results of the impregnated particulate interpenetrating network polymer materials of Examples 2-4 are summarized in Tables 1, 2 and 3.

TABLE 1

| | | Initial Total Volatile Content |
|---|---|---|
| | | (ITVC)⁽⁵⁾ |
| Example | Expansion Agent | (Percent by Weight) |
| 1 | Isopentane | 10.3% |
| 2 | 1,1,1,3,3-pentafluorobutane⁽³⁾ | 9.8% |
| 3 | 1,1,1,3,3-pentafluorobutane | 9.3% |
| | and | |
| | 1,1,1,2,3,3,3-heptafluoro- | |
| | propane⁽⁴⁾ | |
| | Weight Ratio = 93:7 | |
| 4 | 1,1,1,3,3-pentafluorobutane | 9.3% |
| | and | |
| | 1,1,1,2,3,3,3-heptafluoro- | |
| | propane | |
| | Weight Ratio = 87:13 | |

⁽³⁾HFC-365mfc 1,1,1,3,3-pentafluorobutane obtained commercially from Solvay Fluor und Derivate GmbH.
⁽⁴⁾HFC-227 1,1,1,2,3,3,3-heptafluoropropane obtained commercially from Solvay Fluor und Derivate GmbH.
⁽⁵⁾The initial total volatile content (ITVC) was determined by measuring the weight loss of approximately 2 grams of 3 separate samples of impregnated particulate interpenetrating network polymer material after exposure to a temperature of 150° C. for 30 minutes in an open container. The values shown in Table 1 are, in each case, averages of the three samples tested.

### Expansion Evaluation

The impregnated particulate interpenetrating network polymer materials of Examples 1 through 4 were evaluated to determine their expandability in accordance with the following description. Approximately 10 grams of impregnated particulate interpenetrating network polymer material was introduced into a 2.5 liter cylindrical stainless steel vessel fitted with a steam port at the base, a vent at the top, and a thermocouple positioned in the middle of the vessel. The vessel was closed, and steam was introduced into the base thereof by manual control of a valve. The introduced steam passed up through the impregnated particulate interpenetrating network polymer material and exited through the vent at the top of the vessel. The vent was adjusted to provide back pressure within the vessel corresponding to the saturated steam pressure associated with the hold temperature recited in Table 2. In each case, it took approximately 10 seconds for the hold temperature recited in Table 2 to be reached. After holding for the time recited in Table 2, the steam valve was manually closed, the vessel was opened and the expanded particulate interpenetrating network polymer material removed therefrom.

TABLE 2

| | ITVC⁽⁵⁾ | | Expanded | |
|---|---|---|---|---|
| | (% by | Expansion | Density⁽⁷⁾ | ETVC⁽⁸⁾ |
| Example | weight) | Conditions⁽⁶⁾ | (Kg/m³) | (% by weight) |
| 1 | 10.3 | 100° C., 15 | 32.5 | 2.2 |
| | | seconds | | |
| 2 | 9.8 | 110° C., 20 | 25.0 | 3.5 |
| | | seconds | | |
| 3 | 9.3 | 110° C., 20 | 25.0 | 3.5 |
| | | seconds | | |
| 4 | 9.3 | 100° C., 15 | 27.0 | 4.3 |
| | | seconds | | |

⁽⁵⁾ITVC = Initial Total Volatile Content of the impregnated particulate interpenetrating network polymer material, in percent by weight. See the description following Table 1.
⁽⁶⁾The expansion conditions are presented as the temperature (+/−2° C.) at, and the time during which the impregnated particulate interpenetrating network polymer material was exposed to steam in the vessel.
⁽⁷⁾The density of the expanded particulate interpenetrating network polymer material was determined by measuring the weight associated with a known volume (approximately 250 ml) of expanded particulate interpenetrating network polymer material. The expanded particulate interpenetrating network polymer material was added to a graduated vessel, which was manually shaken to settle the expanded particulate material, the volume was recorded, and the weight of the expanded particulate material measured. For purposes of conversion and reference, 1 pound/ft³ (pcf) equals 16.0 Kg/m³.
⁽⁸⁾ETVC = Expanded Total Volatile Content of the expanded particulate interpenetrating network polymer material, in percent by weight. The ETVC values were determined by measuring the weight loss of approximately 0.5 to 1 gram of expanded particulate interpenetrating network polymer material after exposure to a temperature of 150° C. for 30 minutes in an open container.

The impregnated particulate interpenetrating network polymer materials of the present invention (e.g., Examples 2, 3 and 4) were found to have acceptable expansion properties relative to those of comparative impregnated particulate interpenetrating network polymer materials (e.g., Example 1). This determination was made qualitatively by visual inspection of the expanded particulate interpenetrating network polymer materials, and quantitatively by comparison of the Expansion Conditions and densities of the expanded materials (as summarized in Table 2).

Molded test samples (having dimensions of 5 cm×10 cm×3.7 cm) of the expanded particulate interpenetrating network polymer materials were prepared in a lab molding device that was exposed to steam at a temperature of 100° C. in an enclosed vessel for a period of 0.5 minutes. Molded test samples prepared from expanded particulate interpenetrating network polymer materials according to the present invention (e.g., as represented by Examples 2 through 4) were determined, by qualitative visual and tactile inspection, to have properties substantially similar to those of molded test samples prepared from comparative expanded particulate interpenetrating network polymer materials (e.g., as represented by Example 1).

### Expansion Agent Retention Evaluation

The impregnated particulate interpenetrating network polymer materials of Examples 1 through 4 were evaluated to determine their expansion agent retention values in accordance with the following description. Approximately 2 grams of impregnated particulate interpenetrating network polymer material was introduced into round open-topped aluminum trays (6.4 cm diameter; 1.3 cm deep). A single layer of impregnated particulate interpenetrating network polymer material covered the base of each aluminum tray. Initial sample weights were recorded, and the sample containing aluminum trays were placed on a laboratory shelf (open and uncovered) and exposed to ambient room conditions. Ambient room temperature ranged from about 25° C. to about 27° C. The samples were periodically weighed over time, the subsequent weights were compared to the initial weights, and expansion agent retention values were determined from the following equations:

A=(Initial Sample Weight)×(ITVC)

B=(Initial Sample Weight)−(Subsequent Sample Weight)

Expansion Agent Retention Value=100×{(A)−(B)}/(A)

The expansion agent retention values are accordingly weight percent values, which are based on the initial weight of expansion agent present within the impregnated particulate interpenetrating network polymer material.

The expansion agent retention values for Examples 1 through 4 are presented in the following Table 3. Three separate samples were evaluated for each impregnated/expandable particulate interpenetrating network polymer material, and the results presented in Table 3 are averages of expansion agent retention values obtained from the 3 samples in each case. A graphical representation of expansion agent retention values as a function of time is presented in the drawing Figure, which is derived from the data of Table 3.

TABLE 3
Expansion Agent Retention Values
Impregnated Particulate Interpenetrating Network Polymer Materials
(percent by weight)

| Time | | | | |
|---|---|---|---|---|
| (hours) | Example 1 | Example 2 | Example 3 | Example 4 |
| 0 | 100 | 100 | 100 | 100 |
| 2 | 75 | 93 | 93 | 96 |
| 4 | 67 | 91 | 90 | 94 |
| 6 | 63 | 89 | 88 | 93 |
| 24 | 47 | 82 | 81 | 86 |
| 48 | 40 | 77 | 76 | 81 |
| 72 | 36 | 74 | 72 | 77 |
| 96 | 33 | 71 | 70 | 73 |
| 168 | 28 | 65 | 64 | 67 |

The data summarized in Table 3 show that impregnated/expandable particulate interpenetrating network polymer materials according to the present invention (e.g., as represented by Examples 2, 3 and 4) have substantially improved expansion agent retention values relative to comparative impregnated/expandable particulate interpenetrating network polymer materials (e.g., as represented by Example 1). After 168 hours (1 week) of aging at ambient conditions: the expandable particulate interpenetrating network polymer materials according to the present invention were found to be sufficiently expandable; while the comparative expandable particulate interpenetrating network polymer material was found to be no longer expandable (as determined by qualitative visual inspection of aged samples that were subjected to the Expansion Evaluation as described relative to Table 2 above).

Plots of percent weight of expansion agent retained as an function of time for the expandable particulate interpenetrating network polymer materials of Examples 1-4 are provided in the drawing Figure. Upon review of the plots in the drawing Figure, it is apparent that expandable particulate interpenetrating network polymer materials according to the present invention, as represented by Examples 2, 3 and 4, have substantially improved expansion agent retention values relative to comparative expandable particulate interpenetrating network polymer materials, as represented by Example 1.

The results summarized in the preceding tables of the present examples demonstrate that expandable (i.e., impregnated) particulate interpenetrating network polymer materials according to the present invention have substantially improved expansion agent retention values, coupled with desirable physical properties, such as expandability and moldability, relative to comparative expandable particulate interpenetrating network polymer materials.

The present invention has been described with reference to specific details of particular embodiments thereof. It is not intended that such details be regarded as limitations upon the scope of the invention except insofar as and to the extent that they are included in the accompanying claims.

What is claimed is:

1. An expandable particulate interpenetrating network polymer comprising:
(a) a particulate interpenetrating network polymer comprising,
(i) a polyolefin polymer present in an amount of from 10 percent by weight to 80 percent by weight, based on total weight of said particulate interpenetrating network polymer, and
(ii) a vinyl aromatic polymer present in an amount of from 20 percent by weight to 90 percent by weight, based on total weight of said particulate interpenetrating network polymer; and
(b) an expansion agent consisting essentially of pentafluorobutane,
and optionally a minor amount of heptafluoropropane, wherein said expansion agent resides substantially within said particulate interpenetrating network polymer.

2. The: expandable particulate interpenetrating network polymer of claim 1 wherein said expansion agent is present in an amount of from 1 percent by weight to 20 percent by weight, based on total weight of said expandable particulate interpenetrating network polymer.

3. The expandable particulate interpenetrating network polymer of claim 1 wherein pentafluorobutane is 1,1,1,3,3-pentafluorobutane, and heptafluoropropane is 1,1,1,2,3,3,3-heptafluoropropane.

4. The expandable particulate interpenetrating network polymer of claim 3 wherein said expansion agent consists essentially of a major amount of 1,1,1,3,3-pentafluorobutane, and a minor amount of 1,1,1,2,3,3,3-heptafluoropropane.

5. The expandable particulate interpenetrating network polymer of claim 4 wherein said expansion agent consists essentially of 1,1,1,3,3-pentafluorobutane present in an amount of 85 to 99 percent by weight, based on total weight of said expansion agent, and 1,1,1,2,3,3,3-heptafluoropropane present in an amount of 1 to 15 percent by weight, based on total weight of said expansion agent.

6. The expandable particulate interpenetrating network polymer of claim 1 wherein said expandable particulate interpenetrating network polymer has an expansion agent retention value of at least 50 percent by weight, based on original weight of expansion agent,
further wherein said expansion agent retention value is determined by exposing said expandable particulate interpenetrating network polymer, in an open container, to conditions of,
a temperature of 250° C.,
a pressure of 1 atmosphere, and
a period of 7 days.

7. The expandable particulate interpenetrating network polymer of claim 1 wherein said expandable particulate interpenetrating network polymer has an expansion agent retention value of at least 60 percent by weight, based on original weight of expansion agent,
further wherein said expansion agent retention value is determined by exposing said expandable particulate interpenetrating network polymer, in an open container, to conditions of,
a temperature of 25° C.,
a pressure of 1 atmosphere, and
a period of 7 days.

8. The expandable particulate interpenetrating network polymer of claim 1 wherein said polyolefin polymer is prepared from an olefin monomer composition comprising ethylene monomer, and optionally a comonomer selected from the group consisting of C₃-C₈-alpha-olefin monomer, vinyl acetate, C₁-C₈-(meth)acrylate and combinations thereof.

9. The expandable particulate interpenetrating network polymer of claim 8 wherein ethylene monomer is present in said olefin monomer composition in an amount of at least 50 percent by weight, based on total weight of said olefin monomer composition.

10. The expandable particulate interpenetrating network polymer of claim 9 wherein said olefin monomer composition comprises ethylene monomer and vinyl acetate.

11. The expandable particulate interpenetrating network polymer of claim 1 wherein said vinyl aromatic polymer is prepared from a vinyl aromatic polymer monomer composition comprising,
(i) a vinyl aromatic monomer present in an amount of from 70 percent by weight to 99 percent by weight, based on total weight of said vinyl aromatic polymer monomer composition, and
(ii) a comonomer present in an amount of from 1 percent by weight to 30 percent by weight, based on total weight of said vinyl aromatic polymer monomer composition.

12. The expandable particulate interpenetrating network polymer of claim 11 wherein said vinyl aromatic monomer is selected from the group consisting of styrene, alpha-methylstyrene, para-methylstyrene, ethylstyrene, chlorostyrene, bromostyrene, vinyltoluene, vinylbenzene, isopropylxylene and combinations thereof.

13. The expandable particulate interpenetrating network polymer of claim 11 wherein said comonomer, of said vinyl aromatic polymer monomer composition, comprises at least one member selected from the group consisting of C₁-C₈-(meth)acrylate.

14. The expandable particulate interpenetrating network polymer of claim 12 wherein said vinyl aromatic monomer is styrene and said comonomer is butyl acrylate.

15. The expandable particulate interpenetrating network polymer of claim 1 wherein said polyolefin polymer is crosslinked with a crosslinking agent.

16. The expandable particulate interpenetrating network polymer of claim 15 wherein said crosslinking agent is selected from the group consisting of di-t-butyl-peroxide, t-butyl-cumylperoxide, dicumyl-peroxide, α,α-bis-(t-butylperoxy)-p-diisopropylbenzene, 2,5 ,-dimethyl-2,5-di-(t-butylperoxy)-hexyne-3,2,5-dimethyl-2,5-di-(benzoylperoxy)-hexyne, t-butyl-peroxyisopropyl-carbonate, polyether poly(t-butyl peroxycarbonate) and combinations thereof.

17. The expandable particulate interpenetrating network polymer of claim 1 further comprising from 0.1 to 5 percent by weight of limonene, based on total weight of said expandable particulate interpenetrating network polymer.

18. The expandable particulate interpenetrating network polymer of claim 1 wherein said particulate interpenetrating network polymer is prepared by a process comprising:
(a) providing said polyolefin polymer in the form of a particulate polyolefin polymer; and
(b) polymerizing said vinyl aromatic polymer monomer composition substantially within said particulate polyolefin polymer.
